(19) United States
(12) Patent Application Publication
(10) Pub. No.: US 2024/0351775 A1
(43) Pub. Date: Oct. 24, 2024

(54) SHOE STORAGE CONTAINER

(71) Applicant: Tonya May, Kimper, KY (US)

(72) Inventor: Tonya May, Kimper, KY (US)

(21) Appl. No.: 18/136,181

(22) Filed: Apr. 18, 2023

(51) Int. Cl. B65D 85/18; B62B 3/00; B65D 25/06; B65D 25/24; B65D 25/28; B65D 43/02

(52) U.S. Cl. CPC B65D 85/187; B62B 3/005; B65D 25/06; B65D 25/24; B65D 25/2808; B65D 43/0204; B62B 2202/65; B65D 2543/00194

(57) ABSTRACT

A shoe storage container apparatus for storing shoes between a furniture piece and a floor surface includes a housing comprising a base and a perimeter wall, in which the perimeter wall is coupled to and extends upwardly from the base. The perimeter wall bounds a compartment and includes a front wall, a rear wall, a first lateral wall, and a second lateral wall. An upper edge of the perimeter wall forms an opening to the compartment. A plurality of dividers is removably coupled to the housing and is selectively positioned to segment the compartment into a plurality of sub-compartments.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to shoe storage apparatus and more particularly pertains to a new shoe storage apparatus for storing shoes between a furniture piece and a floor surface.

### (2) Description of Related Art including information disclosed under 37 CFR 1.97 and 1.98

The prior art discloses myriad shoe storage apparatuses, including apparatuses which store matching pairs of shoes in separate compartments. However, the prior art does not disclose a shoe storage apparatus with dividers that are selectively positionable in a housing to define sub-compartments of various sizes and in which the housing is sized to fit between a furniture piece and a floor surface.

### BRIEF SUMMARY OF THE INVENTION

An embodiment of the disclosure meets the needs presented above by generally comprising a housing comprising a base and a perimeter wall, in which the perimeter wall is coupled to and extends upwardly from the base. The perimeter wall bounds a compartment and includes a front wall, a rear wall, a first lateral wall, and a second lateral wall. An upper edge of the perimeter wall forms an opening to the compartment. A plurality of dividers is removably coupled to the housing and is selectively positioned to segment the compartment into a plurality of sub-compartments.

Another embodiment of the disclosure includes a method of storing a plurality of matching pairs of shoes in a shoe storage container apparatus under a furniture piece. The method comprises positioning a plurality of dividers into a compartment of a housing of the shoe storage container apparatus to segment the compartment into a plurality of sub-compartments, wherein the compartment is positioned in the housing and has an opening to the compartment at a top of the housing. The matching pairs of shoes are positioned in selected corresponding sub-compartments of the plurality of sub-compartments, and the shoe storage container apparatus is moved along a floor surface and underneath the furniture piece.

When positioning the plurality of the dividers into the compartment, each divider may be placed to extend between an interior wall and one of the first and second lateral walls of the housing, the first and second lateral walls being positioned opposite each other across the compartment and the interior wall being positioned between the first and second lateral walls. Each divider may also be positioned into separate receivers of a plurality of receivers, wherein each of the interior wall and the first and second lateral walls has a plurality of receivers positioned thereon.

The method may also comprise attaching a lid to the top of the housing to cover the opening. The shoe storage container apparatus may have wheels so that the step of moving the shoe storage container apparatus comprises rolling the shoe storage container apparatus on the wheels.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top front side perspective view of a shoe storage container apparatus according to an embodiment of the disclosure.

FIG. 2 is a top front side perspective view of an embodiment of the disclosure.

FIG. 3 is a top front side perspective view of an embodiment of the disclosure with a lid removed from the apparatus.

FIG. 4 is a top back side perspective view of an embodiment of the disclosure with a lid removed from the apparatus.

FIG. 5 is a top in-use view of an embodiment of the disclosure with a lid removed from the apparatus.

FIG. 6 is a side view of an embodiment of the disclosure.

FIG. 7 is a back view of an embodiment of the disclosure.

FIG. 8 is an in-use view of an embodiment of the disclosure.

### DETAILED DESCRIPTION OF THE INVENTION

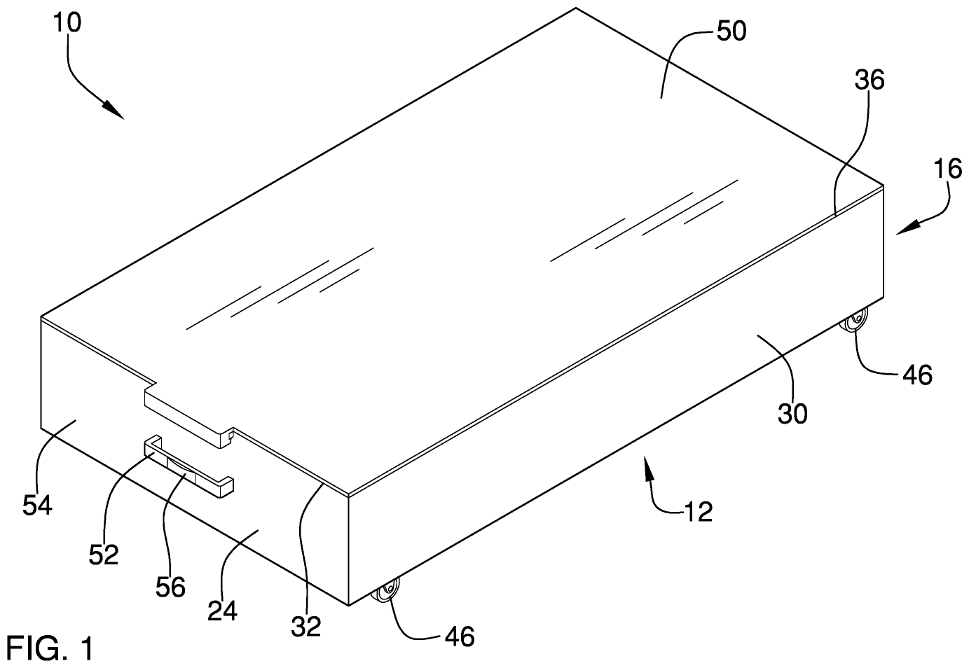

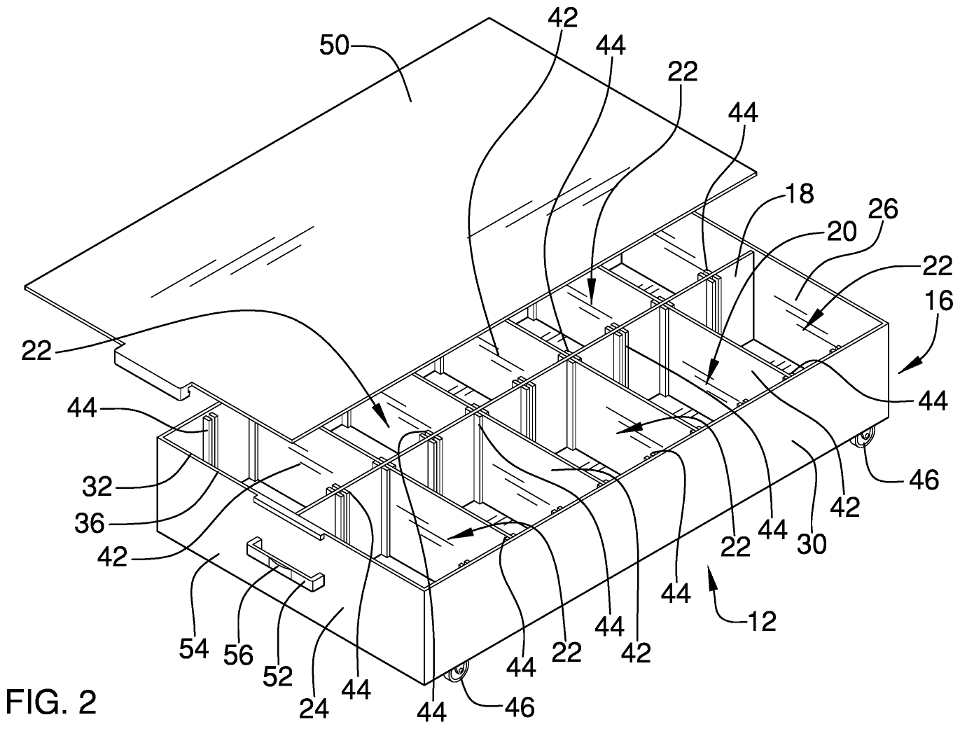

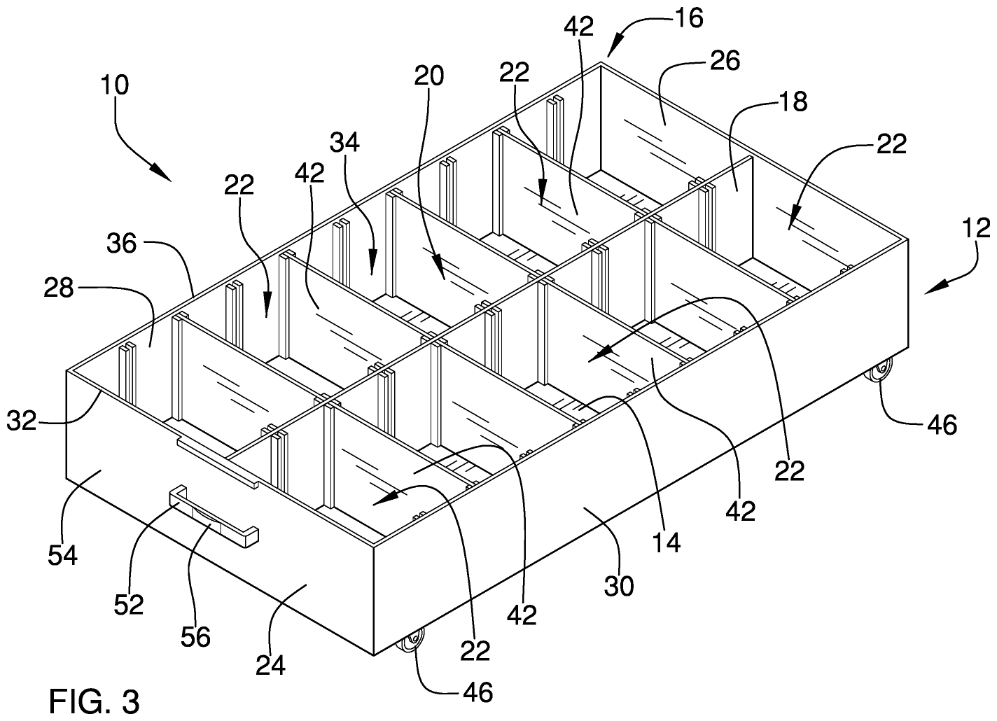

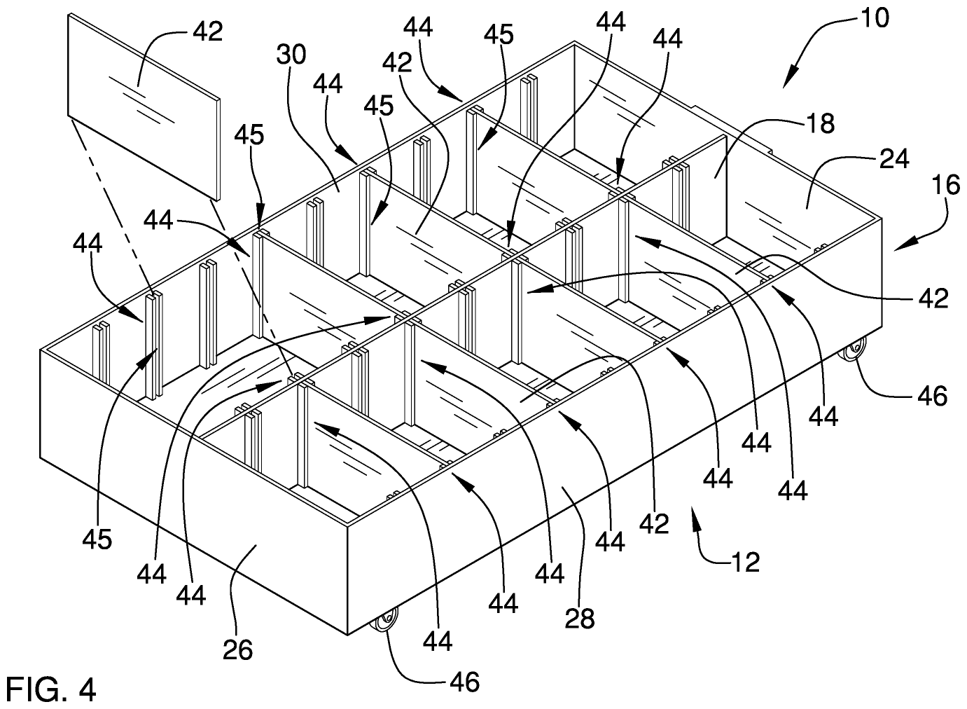

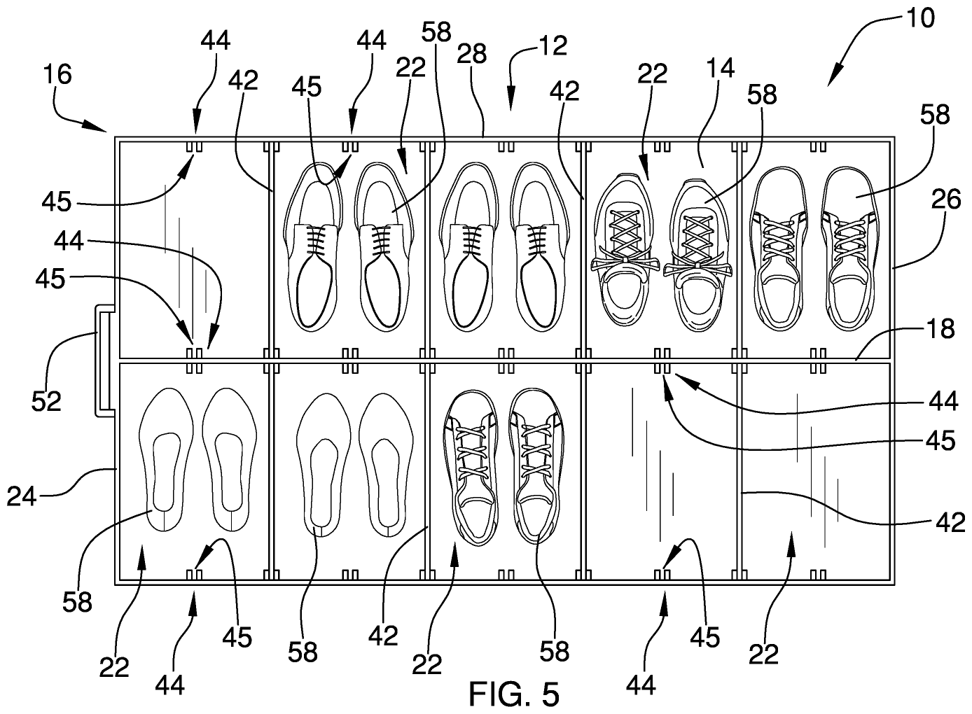

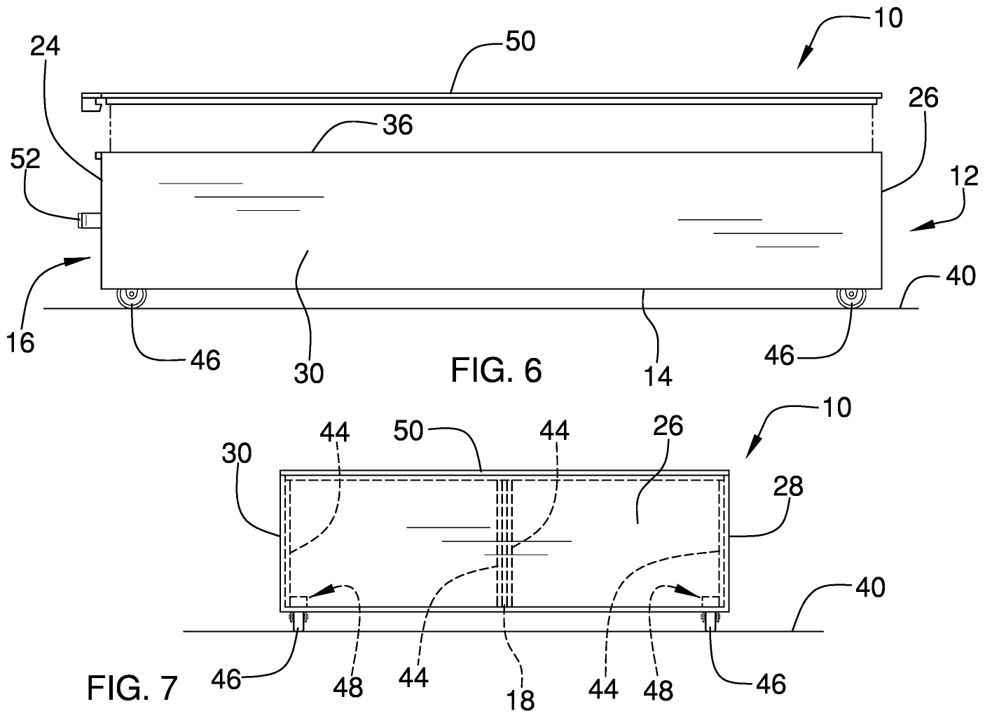

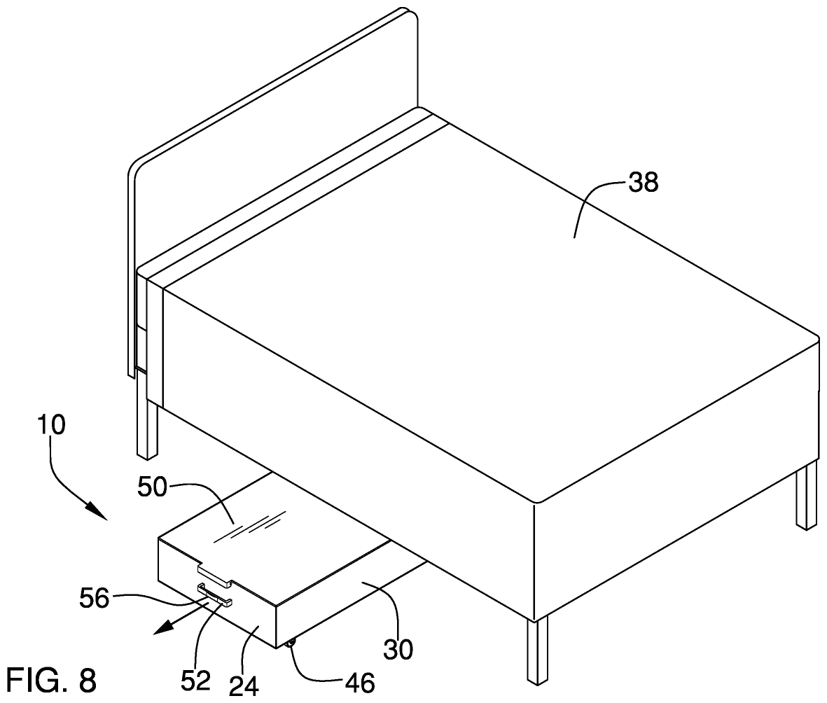

With reference now to the drawings, and in particular to FIGS. 1 through 8 thereof, a new shoe storage apparatus embodying the principles and concepts of an embodiment of the disclosure and generally designated by the reference numeral 10 will be described.

As best illustrated in FIGS. 1 through 8, the shoe storage container apparatus 10 generally comprises a housing 12 comprises a base 14, a perimeter wall 16, and an interior wall 18. The perimeter wall 16 is coupled to and extends upwardly from the base 14. The perimeter wall 16 bounds a compartment 20 and includes a front wall 24, a rear wall 26, a first lateral wall 28, and a second lateral wall 30. An upper edge 32 of the perimeter wall 16 forms an opening 34 to the compartment 20. The interior wall 18 is coupled to and extends between the front wall 24 and the rear wall 26. The interior wall 18 is also centered between the first and second lateral walls 28, 30. The housing 12 has a height from the base 14 to a top 36 of the housing 12 such that the housing 12 is configured for positioning between a furniture piece 38 and a floor surface 40. The height of the housing 12 is between 5.0 inches and 9.0 inches. The housing 12 also has a length from the front wall 24 to the rear wall 26 of between 35.0 inches and 45.0 inches and a width from the first lateral wall 28 to the second lateral wall 30 of between 20.0 inches and 26.0 inches. The furniture piece 38 may be, for example, a bed, but also may be a bench, couch, dresser, or the like.

A plurality of dividers 42 is removably coupled to the housing 12 and is selectively positioned to segment the compartment 20 into a plurality of sub-compartments 22. Each divider 42 of the plurality of dividers 42 extends between the interior wall 18 and one of the first and second lateral walls 28, 30. A plurality of receivers 44 is coupled to the housing 12. Each of the interior wall 18 and the first and second lateral walls 28, 30 has some of the plurality of receivers 44 positioned thereon, and each receiver 44 releasably engages one of the plurality of dividers 42.

Each receiver 44 in the first and second lateral walls 28, 30 is positioned opposite one of the plurality of receivers 44 in the interior wall 18. The receivers 44 on a corresponding one of the first lateral wall 28, second lateral wall 30, and interior wall 18 are evenly spaced from each other. A spacing between each pair of adjacent receivers 44 of the plurality of receivers 44 is between 3.0 inches and 5.0 inches. Each receiver 44 of the plurality of receivers 44 comprises a vertically orientated channel 45 which extends into the corresponding one of the first lateral wall 28, the second lateral wall 30, and the interior wall 18.

A plurality of wheels 46 is coupled to the base 14 of the housing 12. The housing 12 has a plurality of recesses 48 extending into the base 14, and each wheel 46 of the plurality of wheels 46 is positioned at least partially in one of the recesses 48. A lid 50 is removably coupled to the top 36 of the housing 12 to cover the opening 34 and has a snap-fit connection to the perimeter wall 16. The lid 50 may also couple to the housing 12 via a latch, a friction fit, or the like. A handle 52 is mounted to an exterior surface 54 of the front wall 24. A sleeve 56 for a label may also be provided and mounted to the housing 12, the lid 50, or the handle 52. The housing 12 and the plurality of dividers 42 comprise a rigid material such that the housing 12 and each divider 42 do not deflect away from each other under a weight force exerted by shoes 58 placed in the housing 12. Such a deflection, which is common in storage containers made of canvas or other flexible materials, can lead to shoes 58 slipping through gaps between sub-compartments 22.

In use, matching pairs of shoes 58 may be positioned in selected corresponding sub-compartments 22 of the plurality of sub-compartments 22. Then the lid 50 is coupled to the top 36 of the housing 12, and the shoe storage container apparatus 10 is moved along the floor surface 40 and under the furniture piece 38.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A shoe storage container apparatus comprising:
a housing comprising:
a base; and
a perimeter wall being coupled to and extending upwardly from the base, the perimeter wall including a front wall, a rear wall, a first lateral wall, and a second lateral wall, the perimeter wall bounding a compartment, an upper edge of the perimeter wall forming an opening to the compartment; and
a plurality of dividers being removably coupled to the housing and being selectively positioned to segment the compartment into a plurality of sub-compartments.

2. The apparatus of claim 1, wherein:
the housing further comprises an interior wall being coupled to and extending between the front wall and the rear wall; and
each divider of the plurality of dividers extends between the interior wall and one of the first and second lateral walls.

3. The apparatus of claim 2, wherein the interior wall is centered between the first and second lateral walls.

4. The apparatus of claim 1, wherein the housing has a height from the base to a top of the housing such that the housing is configured for positioning between a furniture piece and a floor surface.

5. The apparatus of claim 4, wherein the height of the housing is between 5.0 inches and 9.0 inches, the housing having a length from the front wall to the rear wall of between 35.0 inches and 45.0 inches, the housing having a width from the first lateral wall to the second lateral wall of between 20.0 inches and 26.0 inches.

6. The apparatus of claim 2, further comprising a plurality of receivers being coupled to the housing, each of the interior wall and the first and second lateral walls having some of the plurality of receivers positioned thereon, each receiver releasably engaging one of the plurality of dividers, each receiver in the first and second lateral walls being positioned opposite one of the plurality of receivers in the interior wall.

7. The apparatus of claim 6, wherein the plurality of receivers on a corresponding one of the first lateral wall, second lateral wall, and interior wall are evenly spaced from each other.

8. The apparatus of claim 7, wherein a spacing between each pair of adjacent receivers of the plurality of receivers is between 3.0 inches and 5.0 inches.

9. The apparatus of claim 6, wherein each receiver of the plurality of receivers comprises a vertically orientated channel extending into the corresponding one of the first lateral wall, the second lateral wall, and the interior wall.

10. The apparatus of claim 1, further comprising a plurality of wheels being coupled to the base of the housing, the housing having a plurality of recesses extending into the base, each wheel of the plurality of wheels being positioned at least partially in one of the recesses.

12. The apparatus of claim 1, further comprising a lid being removably coupled to the top of the housing to cover the opening, the lid having a snap-fit connection to the perimeter wall.

13. The apparatus of claim 1, further comprising a handle being mounted to an exterior surface of the front wall.

14. The apparatus of claim 1, wherein the housing and the plurality of dividers comprise a rigid material such that the housing and each divider do not deflect away from each other under a weight force exerted by shoes placed in the housing.

15. A shoe storage container apparatus comprising:
a housing comprising:
a base;
a perimeter wall being coupled to and extending upwardly from the base, the perimeter wall including a front wall, a rear wall, a first lateral wall, and a second lateral wall, the perimeter wall bounding a compartment, an upper edge of the perimeter wall forming an opening to the compartment; and
an interior wall being coupled to and extending between the front wall and the rear wall, the interior wall being centered between the first and second lateral walls;
the housing having a height from the base to a top of the housing such that the housing is configured for positioning between a furniture piece and a floor surface, the height of the housing being between 5.0 inches and 9.0 inches, the housing having a length from the front wall to the rear wall of between 35.0 inches and 45.0 inches, the housing having a width from the first lateral wall to the second lateral wall of between 20.0 inches and 26.0 inches;
a plurality of dividers being removably coupled to the housing and being selectively positioned to segment the compartment into a plurality of sub-compartments, each divider of the plurality of dividers extending between the interior wall and one of the first and second lateral walls;
a plurality of receivers being coupled to the housing, each of the interior wall and the first and second lateral walls having some of the plurality of receivers positioned thereon, each receiver releasably engaging one of the plurality of dividers, each receiver in the first and second lateral walls being positioned opposite one of the plurality of receivers in the interior wall, the plurality of receivers on a corresponding one of the first lateral wall, second lateral wall, and interior wall being evenly spaced from each other, a spacing between each pair of adjacent receivers of the plurality of receivers being between 3.0 inches and 5.0 inches, each receiver of the plurality of receivers comprising a vertically orientated channel extending into the corresponding one of the first lateral wall, the second lateral wall, and the interior wall;
a plurality of wheels being coupled to the base of the housing, the housing having a plurality of recesses extending into the base, each wheel of the plurality of wheels being positioned at least partially in one of the recesses;
a lid being removably coupled to the top of the housing to cover the opening, the lid having a snap-fit connection to the perimeter wall;
a handle being mounted to an exterior surface of the front wall; and
wherein the housing and the plurality of dividers comprise a rigid material such that the housing and each divider do not deflect away from each other under a weight force exerted by shoes placed in the housing.

16. A method of storing a plurality of matching pairs of shoes in a shoe storage container apparatus under a furniture piece, the method comprising:
positioning a plurality of dividers into a compartment of a housing of the shoe storage container apparatus to segment the compartment into a plurality of sub-compartments, wherein the compartment is positioned in the housing and has an opening to the compartment at a top of the housing;
positioning each matching pair of shoes in selected corresponding sub-compartments of the plurality of sub-compartments; and
moving the shoe storage container apparatus along a floor surface and underneath the furniture piece.

17. The method of claim 16, wherein the step of positioning the plurality of dividers into the compartment further comprises positioning each divider to extend between an interior wall and one of a first lateral wall and a second lateral wall of the housing, wherein the first lateral wall and the second lateral wall are positioned opposite each other across the compartment, wherein the interior wall is positioned between the first and second lateral walls.

18. The method of claim 17, wherein the step of positioning the plurality of dividers into the compartment further comprises positioning each divider into separate receivers of a plurality of receivers, wherein each of the interior wall and the first and second lateral walls has a plurality of receivers positioned thereon.

19. The method of claim 16, further comprising attaching a lid to the top of the housing to cover the opening.

20. The method of claim 16, wherein the step of moving the shoe storage container apparatus comprises rolling the shoe storage container apparatus on wheels attached to the housing.
